(19) United States
(12) Patent Application Publication
(10) Pub. No.: US 2014/0340841 A1
(43) Pub. Date: Nov. 20, 2014

(54) HANDHELD COMMUNICATION DEVICE WITH HEAT DISSIPATING STRUCTURE

(71) Applicant: CHAUN-CHOUNG TECHNOLOGY CORP., NEW TAIPEI CITY (TW)

(72) Inventors: Chia-Hsing YU, NEW TAIPEI CITY (TW); Ming-Chih WU, New Taipei City (TW)

(73) Assignee: CHAUN-CHOUNG TECHNOLOGY CORP., NEW TAIPEI CITY (TW)

(21) Appl. No.: 14/186,368

(22) Filed: Feb. 21, 2014

(30) Foreign Application Priority Data
May 17, 2013 (TW) 102209866

(51) Int. Cl. G06F 1/20

(52) U.S. Cl. CPC G06F 1/203
USPC 361/679.47

(57) ABSTRACT

A handheld communication device with a heat dissipating structure includes a housing, a heat generating unit and a heat dissipator. The housing includes a chamber formed therein; the heat generating unit is received inside the chamber; the heat dissipator is arranged corresponding to the heat generating unit. The heat dissipator includes a heat pipe and a heat conductive plate. The heat pipe includes one end thermally attached to the heat generating unit and another end arranged away from the heat generating unit, and the heat conductive plate is thermally attached to the heat pipe. With such structure, the heat generated by the heat generating unit can be uniformly conducted to the heat conductive plate in order to prevent the accumulation of heat at the surrounding of the heat generating unit and to improve the efficiency of the heat dissipation of the device.

### BACKGROUND OF THE INVENTION

1. Field of the Invention

The present invention is related to a handheld communication device, in particular, to a handheld communication device with a heat dissipating structure.

2. Description of Related Art

Handheld communication devices, including such as mobile phones, personal digital assistants (PDA), electronic readers and tablet computers, are developed to have greater computing powers and performances such that the internal components, including such as the central processors and integrated circuits, of modern handheld communication devices all generate a significant amount of heat during their operations, which needs to be dissipated effectively in order to maintain the proper operation and performance of these components as well as their useful lifetimes.

Currently, a known heat dissipator utilized in a conventional handheld communication devices typically comprise a heat conductive plate made of a metal material in such a way that the heat conductive plate is directly attached to a heat generating unit, including such as a central processor and an integrated circuit, and the thermal energy or heat generated by the heat generating unit can be conducted to the heat conductive plate for dissipation thereof to achieve the effect of heat dissipation of the device.

However, the aforementioned known heat dissipator merely utilizes the heat conductive plate to be directly attached to the heat generating unit, which causes the efficiency of the heat dissipation away from the heat generating unit to be too slow and tends to allow the thermal energy or heat to accumulate at parts of the heat conductive plate adjacent to the heat generating unit. In other words, the thermal energy is very likely to build up around the surrounding of the heat generating unit and the efficiency of the heat dissipation away from the heat generating unit is poor.

In view of the above, the inventor seeks to provide a novel solution to overcome the aforementioned drawbacks associated with the known arts along with years of experience and application of theoretical principles in the field.

### SUMMARY OF THE INVENTION

An objective of the present invention is to provide a handheld communication device with a heat dissipating structure capable of utilizing a heat pipe to uniformly conduct the thermal energy generated by a heat generating unit to a heat conductive plate in order to prevent the accumulation of thermal energy or heat at the surrounding of the heat generating unit and such that the technical effect of increased efficiency of heat dissipation can be achieved.

To achieve the aforementioned objective, the present invention provides a handheld communication device with a heat dissipating structure comprising:

a housing having a chamber formed therein;

a heat generating unit received inside the chamber; and

a heat dissipator arranged corresponding to the heat generating unit; the heat dissipator comprising:

a heat pipe having one end thermally attached to the heat generating unit and another end arranged at a direction away from the heat generating unit; and

a heat conductive plate thermally attached to the heat pipe.

The present invention further includes at least the following technical effects and merits:

(1) The performances of heat conduction and heat dissipation of the heat pipe are greater than the ones of the heat conductive plate. Therefore, the heat dissipator of the present invention advantageously utilizing the heat pipe to thermally attach to the heat generating unit and the heat conductive plate is able to uniformly conduct the thermal energy generated by the heat generating unit to the heat conductive plate in a direction away from the heat generating unit in order to prevent the accumulation of the thermal energy building up at the surrounding of the heat generating unit and such that the effectiveness of the heat conductive plate can be improved to uniformly distribute the thermal energy to the handheld communication device via such heat conductive plate. As a result, the heat dissipator of the present invention has a greater efficiency of heat dissipation.

(2) The heat pipe is bent to include bending sections. The heat pipe is disposed on the heat conductive plate with at least one bending sections such that the heat pipe is winding on the heat conductive plate over a large area in order to increase the contact area of the thermal attachment between the heat pipe and the heat conductive plate. As a result, the effectiveness of the heat dissipation of the heat dissipator can be enhanced.

(3) The heat dissipator further comprises a metal sheet. The metal sheet is thermally attached to the heat generating unit and is bent to include a U-shaped bending portion in addition to that the heat pipe penetrates through and is secured inside the U-shaped bending portion. Therefore, the non-uniform surface of the heat pipe is able to firmly contact with the metal sheet and the heat generating unit for heat transfer therebetween and such that the efficiency of the heat dissipation of the heat dissipator is stable and reliable.

(4) The heat pipe and the metal sheet are secured onto the heat conductive plate. The metal sheet includes one surface thermally attached to the heat generating unit and another surface thermally attached to the heat conductive plate in addition to that U-shaped bending portion is arranged on one side of the heat generating unit to allow the heat conductive plate to be stacked onto the heat generating unit. Furthermore, the U-shaped bending portion is able to allow the heat pipe to align on one side of the heat generating unit in parallel in order to prevent the waste of confined space and thickness for accommodating the heat conductive plate and the heat pipe inside the chamber of the housing. As a result, the handheld communication device is of the merits of being slim in size and light in weight.

(5) The heat dissipator further comprises the auxiliary heat conductive plate and the auxiliary heat conductive plate is thermally attached to the heat conductive plate such that efficiency of the heat dissipation of the heat dissipator is enhanced and the heat dissipator is able to even more uniformly dissipate the heat to the handheld communication device. As a result, the heat dissipator of the present invention has an excellent efficiency of heat dissipation.

(6) A receiving zone is formed between the inner side of the heat pipe and the heat conductive plate and the auxiliary heat conductive plate is received inside the receiving zone such that there is no need for additional space and thickness to accommodate the auxiliary heat conductive plate inside the chamber. As a result, the size of the handheld communication device can be maintained to be slim and light with a relatively simple structure.

### BRIEF DESCRIPTION OF DRAWING

FIG. 1 is an exploded view of a first embodiment of the handheld communication device of the present invention;

FIG. 2 is an illustration showing the assembly of the first embodiment of the handheld communication device of the present invention;

FIG. 3 is another illustration showing the assembly of the first embodiment of the handheld communication device of the present invention;

FIG. 4 is an illustration showing a state of use of the first embodiment of the handheld communication device of the present invention;

FIG. 5 is an illustration showing a state of use of a second embodiment of the handheld communication device of the present invention;

FIG. 6 is an illustration showing a state of use of a third embodiment of the handheld communication device of the present invention; and

FIG. 7 is an illustration showing a state of use of a fourth embodiment of the handheld communication device of the present invention.

### DETAILED DESCRIPTION OF THE INVENTION

The following provides detailed description of embodiments of the present invention along with the accompanied drawings. It can, however, be understood that the accompanied drawings are provided for illustrative purposes only and shall not be treated as limitations to the present invention.

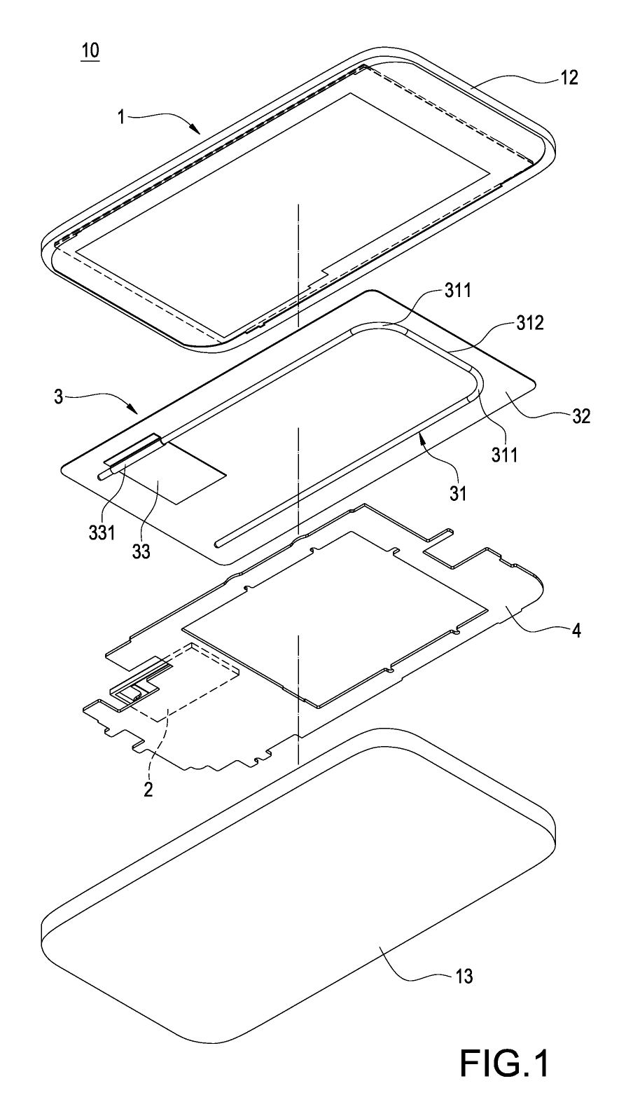

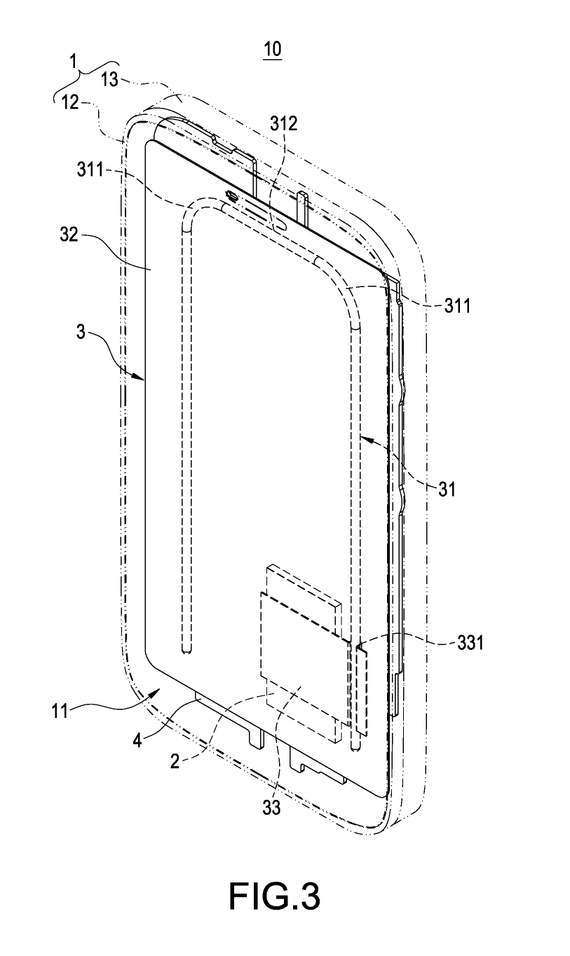

Please refer to FIG. 1 to FIG. 4. The present invention provides a handheld communication device with a heat dissipating structure. The handheld communication device 10 of the present invention mainly comprises a housing 1, a heat generating unit 2 and a heat dissipator 3.

The housing 1 includes a chamber formed therein. To be more specific, the housing 1 is constructed by an upper housing member 12 and a lower housing member 13, and the chamber 11 is formed in the internal of the upper housing member 12 and the lower housing member 13.

The heat generating unit 2 can be an electronic component including such as a central processor and an integrated circuit; however, it is not limited to such components only. The heat generating unit 2 is received inside the chamber 11.

The heat dissipator 3 is arranged corresponding to the heat generating unit 2; therefore, the heat dissipator 3 is also received inside the chamber 11. The heat dissipator 3 comprises a heat pipe 31 and a heat conductive plate 32.

The heat pipe 31 can be a circular-type pipe or a flat-type pipe with a circular-shaped or flat-shaped cross section and includes one end thermally attached to the heat generating unit 2 and another end arranged in a direction away from the heat generating unit 2. Furthermore, the heat pipe 31 is bent to include at least one bending section 311.

According to one embodiment of the present invention, the at least one bending section 311 includes two bending sections, and the heat pipe 31 includes a U-shaped pipe member 312 extended from one end thereof away from the heat generating unit 2; in addition, the two bending sections 311 are formed on the U-shaped pipe member 312.

The heat conductive plate 32 is a flat plate. The heat conductive plate 32 is thermally attached to the heat pipe; wherein the heat conductive plate 32 can be made of a material of such as graphite, ceramic or metal. According to a preferred embodiment of the present invention, the heat conductive plate 32 is made of a metal material.

The heat dissipator 3 further comprises a metal sheet 33. The metal sheet 33 is thermally attached to the heat generating unit 2 and is bent to include a U-shaped bending portion 331. The heat pipe 31 penetrates through and is secured inside the U-shaped bending portion 331. In addition, the heat pipe 31 and the metal plate 33 are secured onto the heat conductive plate 32; wherein the metal sheet 33 includes one surface thermally attached to the heat generating unit 2 and another surface thermally attached to the heat conductive plate 32, and the U-shaped bending portion 331 is arranged on one side of the heat generating unit 2.

The handheld communication device further comprises a circuit board 4. The circuit board 4 is received inside the chamber 11 and is stacked onto the heat conductive plate 32, and the heat generating unit 2 is installed on the circuit board 4.

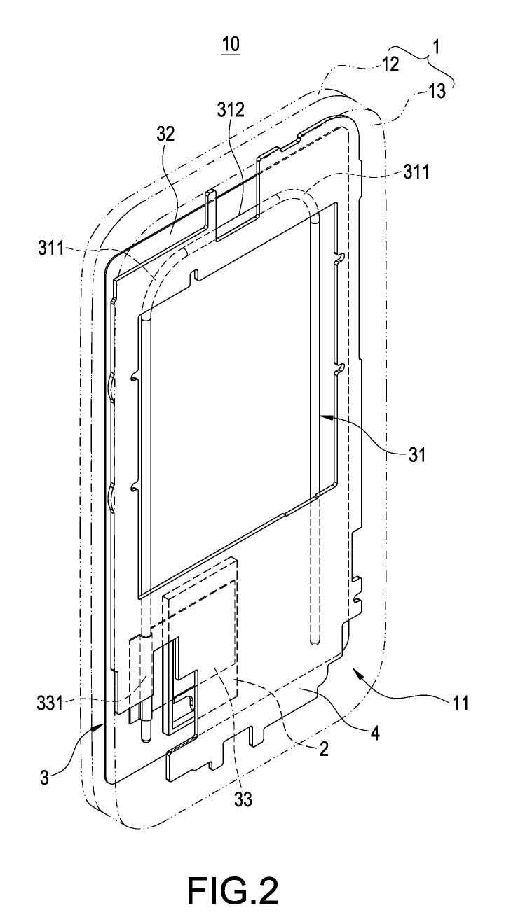

As shown in FIG. 2 to FIG. 4, according to an assembly of the handheld communication device 10 with a heat dissipating structure of the present invention, the present invention is able to utilize the configuration in which the housing 1 having the chamber 11 formed therein, the heat generating unit 2 received inside the chamber 11, the heat dissipator 3 arranged corresponding to the heat generating unit 2, the heat pipe 31 having one end thermally attached to the heat generating unit 2 and another end arranged in a direction away from the heat generating unit 2 and the heat conductive plate 32 thermally attached to the heat pipe 31 in order to uniformly conduct the thermal energy or heat generated by the heat generating unit 2 to the heat conductive plate 32 such that the accumulation of thermal energy at the surrounding of the heat generating unit can be prevented and the increased efficiency of heat dissipation of the heat dissipator 3 can be achieved.

In comparison to the known heat dissipator in a handheld communication device which typically utilizes only the heat conductive plate to thermally attach to the heat generating unit directly and causes the thermal energy to accumulate at parts adjacent to the heat generating unit as well as the accumulation of the heat at the surrounding of the heat generating unit, the present invention is able to overcome such drawback with effective heat dissipation as mentioned above.

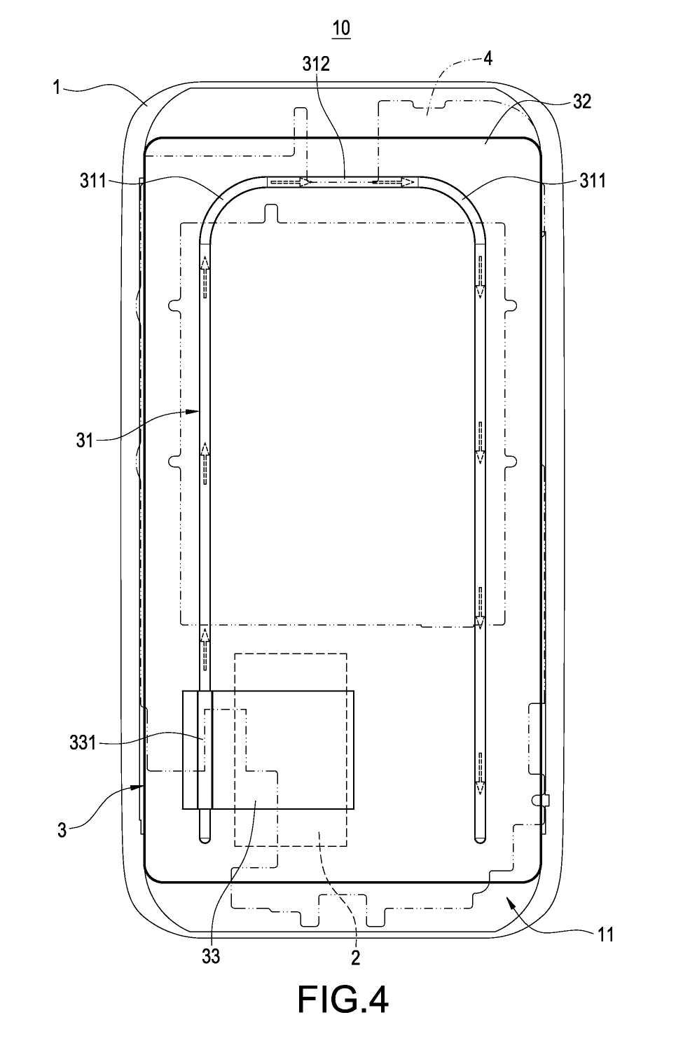

FIG. 4 shows a state of use of the handheld communication device 10 with a heat dissipating structure of the present invention. As shown in the figure, since the performances of heat conduction and heat dissipation of the heat pipe 31 are greater than the ones of the heat conductive plate 32. The heat dissipator 3 of the present invention advantageously utilizing the heat pipe 31 to thermally attach to the heat generating unit 2 and the heat conductive plate 32 is able to uniformly conduct the thermal energy generated by the heat generating unit 2 to the heat conductive plate 32 in a direction away from the heat generating unit 2 in order to prevent the accumulation of the thermal energy building up at the surrounding of the heat generating unit 2 and such that the effectiveness of the heat conductive plate 32 can be improved to uniformly distribute the thermal energy to the handheld communication device 10 via such heat conductive plate 32. As a result, the heat dissipator 3 of the present invention has a greater efficiency of heat dissipation.

Furthermore, the heat pipe 31 is bent to include bending sections 311. The heat pipe 31 is disposed on the heat conductive plate 32 with at least one bending sections 311 such that the heat pipe 31 is winding on the heat conductive plate 32 over a large area in order to increase the contact area of the thermal attachment between the heat pipe 31 and the heat conductive plate 32. As a result, the effectiveness of the heat dissipation of the heat dissipator 3 can be enhanced.

In addition, the heat dissipator 3 further comprises a metal sheet 33. The metal sheet 33 is thermally attached to the heat generating unit 2 and is bent to include a U-shaped bending portion 331 in addition to that the heat pipe 31 penetrates through and is secured inside the U-shaped bending portion 331. Therefore, the non-uniform surface of the heat pipe 31 is able to firmly contact with the metal sheet 33 and the heat generating unit 2 for heat transfer therebetween and such that the efficiency of the heat dissipation of the heat dissipator 3 is stable and reliable.

Moreover, the heat pipe 31 and the metal sheet 33 are secured onto the heat conductive plate 32. The metal sheet 33 includes one surface thermally attached to the heat generating unit 2 and another surface thermally attached to the heat conductive plate 32 in addition to that U-shaped bending portion 331 is arranged on one side of the heat generating unit 2 to allow the heat conductive plate 32 to be stacked onto the heat generating unit 2. Furthermore, the U-shaped bending portion 331 is able to allow the heat pipe 31 to align on one side of the heat generating unit 2 in parallel in order to prevent the waste of confined space and thickness for accommodating the heat conductive plate 32 and the heat pipe 31 inside the chamber 11 of the housing. As a result, the handheld communication device 10 is of the merits of being slim in size and light in weight.

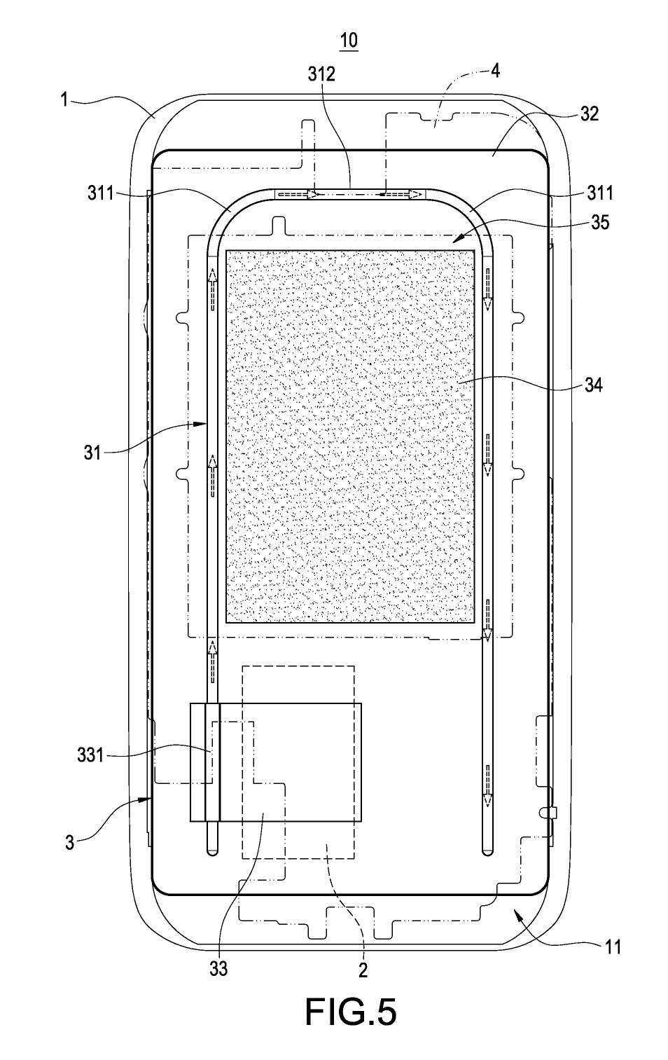

Please refer to FIG. 5 showing a second embodiment of the handheld communication device of the present invention. As shown in the figure, the heat dissipator 3 further comprises an auxiliary heat conductive plate 34. The auxiliary heat conductive plate 34 is thermally attached to the heat conductive 32. The auxiliary conductive plate 34 can be made of a material such as graphite, ceramic or metal. According to a preferred embodiment of the present invention, the auxiliary heat conductive plate 34 is made of a graphite material.

Accordingly, the auxiliary heat conductive plate 34 is thermally attached to the heat conductive plate 32 such that efficiency of the heat dissipation of the heat dissipator 3 is enhanced and the heat dissipator 3 is able to even more uniformly dissipate the heat to the handheld communication device 10. As a result, the heat dissipator 3 of the present invention has an excellent efficiency of heat dissipation.

In addition, as the heat pipe 31 can be configured to have a geometric outer shape of such as a U-shaped pipe member 312 or an L-shaped pipe member, in which the heat pipe 31 with the U-shaped pipe member 312 is exemplarily illustrated in this embodiment, a receiving zone 35 is formed between the inner side of the heat pipe 31 and the heat conductive plate 32, and the auxiliary heat conductive plate 34 is received inside the receiving zone 35 such that there is no need for additional space and thickness to accommodate the auxiliary heat conductive plate 34 inside the chamber. As a result, the size of the handheld communication device 10 can be maintained to be slim and light with a relatively simple structure.

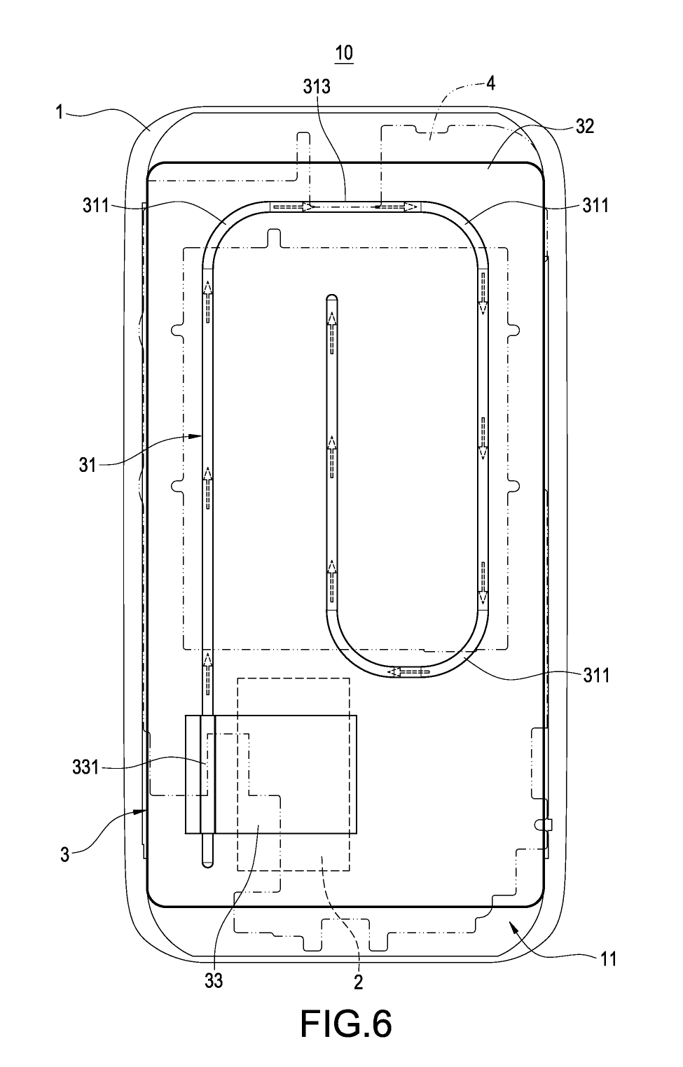

Please refer to FIG. 6 showing a third embodiment of the handheld communication device of the present invention. As shown in the figure, the aforementioned at least one bending section 311 includes a plurality of bending sections, and the heat pipe 31 includes a spiral-shaped pipe member 313 extended on one end thereof away from the heat generating unit 2. The plurality of bending sections 311 are formed on the spiral-shaped pipe member 313 such that the heat pipe 31 is able to wind on the heat conductive plate 32 over a large area in order to increase the contact area of thermal attachment between the heat pipe 31 and the heat conductive plate 32. As a result, the efficiency of the heat dissipation of the heat dissipator 3 can be enhanced.

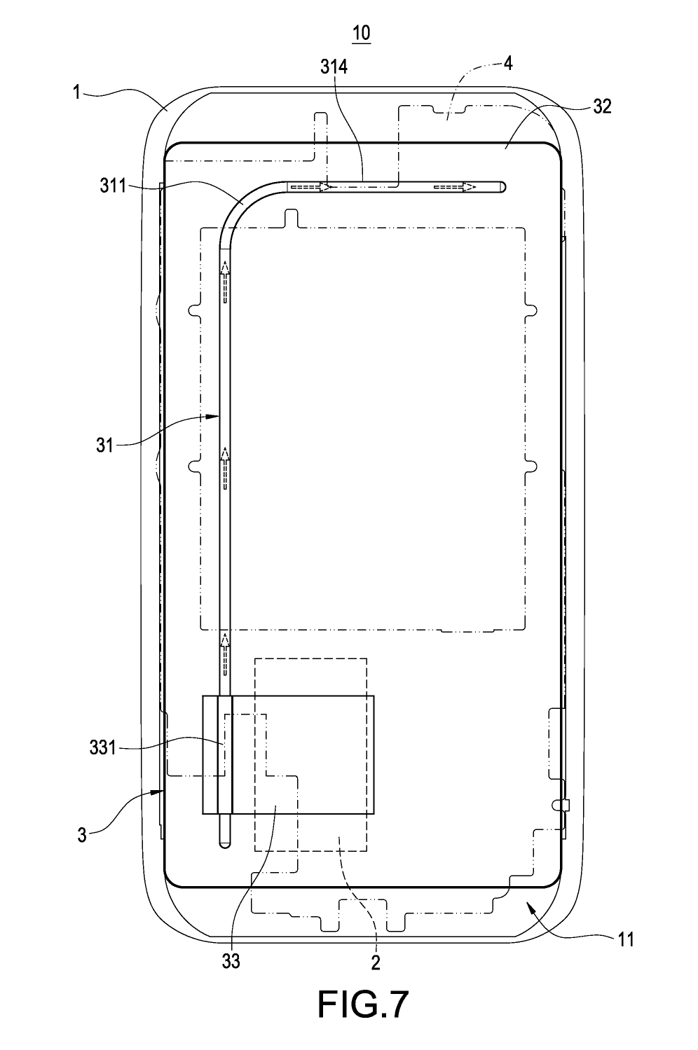

Please refer to FIG. 7 showing a fourth embodiment of the handheld communication device of the present invention. As shown in the figure, the aforementioned at least one bending section 311 includes one bending section, and the heat pipe 31 includes an L-shaped pipe member 314 extended on one end thereof away from the heat generating unit 2. The one bending section 311 is formed on the L-shaped pipe member 314 such that the heat pipe 31 is disposed on the heat conductive plate 32 with a bend in order to increase the contact area of thermal attachment between the heat pipe 31 and the heat conductive plate 32. As a result, the efficiency of the heat dissipation of the heat dissipator 3 can be enhanced.

In view of the above, the handheld communication device with heat dissipating structure of the present invention is able to achieve the objectives expected and to overcome the drawbacks of known arts, which is of novelty and inventive step to comply with the requirements of patentability and is applied legitimately for the grant of the patent right.

What is claimed is:

1. A handheld communication device with a heat dissipating structure comprising:
a housing having a chamber formed therein;
a heat generating unit received inside the chamber; and
a heat dissipator arranged corresponding to the heat generating unit; the heat dissipator comprising:
a heat pipe having one end thermally attached to the heat generating unit and another end arranged at a direction away from the heat generating unit; and
a heat conductive plate thermally attached to the heat pipe.

2. The handheld communication device with a heat dissipating structure according to claim 1, wherein the heat pipe is bent to include at least one bending section.

3. The handheld communication device with a heat dissipating structure according to claim 2, wherein the at least one bending section includes one bending section; the heat pipe includes an L-shaped pipe member extended from one end thereof away from the heat generating unit; the one bending section is formed on the L-shaped pipe member.

4. The handheld communication device with a heat dissipating structure according to claim 2, wherein the at least one bending section includes two bending sections; the heat pipe includes a U-shaped pipe member extended from one end thereof away from the heat generating unit; the two bending sections are formed on the U-shaped pipe member.

5. The handheld communication device with a heat dissipating structure according to claim 2, wherein the at least one bending section includes a plurality of bending sections; the heat pipe includes an spiral-shaped pipe member extended from one end thereof away from the heat generating unit; the plurality of bending sections are formed on the spiral-shaped pipe member.

6. The handheld communication device with a heat dissipating structure according to claim 1, wherein the heat dissipator further comprises a metal sheet; the metal sheet is thermally attached to the heat generating unit and is bent to include a U-shaped bending portion; the heat pipe penetrates through and is secured inside the U-shaped bending portion.

7. The handheld communication device with a heat dissipating structure according to claim 6, wherein the heat pipe and the metal sheet are secured onto the heat conductive plate; the metal sheet includes one surface thermally attached to the heat generating unit and another surface thermally attached to the heat conductive plate; the U-shaped bending portion is arranged on one side of the heat generating unit.

8. The handheld communication device with a heat dissipating structure according to claim 1, wherein the heat dissipator further comprises an auxiliary heat conductive plate; the auxiliary heat conductive plate is thermally attached to the heat conductive plate.

9. The handheld communication device with a heat dissipating structure according to claim 8, wherein a receiving zone is formed between an inner side of the heat pipe and the heat conductive plate; the auxiliary heat conductive plate is received inside the receiving zone.

10. The handheld communication device with a heat dissipating structure according to claim 1, further comprising a circuit board; the circuit board is arranged inside the chamber and is stacked onto the heat conductive plate, and the heat generating unit is installed on the circuit board.
